(19) United States
(12) Patent Application Publication
(10) Pub. No.: US 2026/0133357 A1
(43) Pub. Date: May 14, 2026

(54) PARTIAL PRIVACY MODULE AND PARTIAL PRIVACY DISPLAY DEVICE

(71) Applicant: DARWIN PRECISIONS CORPORATION, Hsinchu County (TW)

(72) Inventors: Jian-Jhih You, Hsinchu County (TW); Wen-Tai Shen, Hsinchu County (TW); YU-HUAN CHIU, Hsinchu County (TW)

(21) Appl. No.: 19/296,997

(22) Filed: Aug. 12, 2025

(30) Foreign Application Priority Data
Nov. 12, 2024 (TW) 113143387

(51) Int. Cl. F21V 8/00

(52) U.S. Cl. CPC G02B 6/0036; G02B 6/0051; G02B 6/002

(57) ABSTRACT

A partial privacy module includes a light control film, a first upper light guide plate, and a first light source. The first upper light guide plate is disposed on a side of the light control film. The first upper light guide plate includes a first light incident surface, a first light emitting surface, a first bottom surface and a plurality of first microstructures. The first microstructures are disposed on at least one of the first light emitting surface and the first bottom surface, wherein the first upper light guide plate has at least one first block and at least one second block adjoined to the at least one first block. The average distribution density of the first microstructures on the first block is greater than the average distribution density of the first microstructures on the second block. A partial privacy display device including the partial privacy module is also provided.

### FIELD OF THE INVENTION

The present invention relates to a privacy module and a privacy display device, and more particularly to a partial privacy module and a partial privacy display device performing partial privacy optionally.

### BACKGROUND OF THE INVENTION

Privacy display devices typically use additional light control films or privacy modules to block the light beams with a large viewing angle from the display device, and thereby only users viewing from a frontal viewing angle can receive the light beams from the display device. It helps to prevent bystanders from viewing the screen contents from two sides or other locations at a large viewing angle, thereby protecting users'viewing privacy. However, when using a display device, a user might have a need of preventing unrelated bystanders from viewing the screen contents together with a need of sharing the screen contents with friends or people nearby at the same time. Since the current privacy display device typically includes a light control film or a privacy module installed therein or has a light control film attached onto the display screen surface, it is obvious that switching freely between the privacy mode and the sharing mode could not be made.

### SUMMARY OF THE INVENTION

The present invention provides a partial privacy module and a partial privacy display device that allows users to switch between a privacy mode and a sharing mode so as to meet the need that a user wants to maintain his/her viewing privacy together with sharing partial screen contents with friends nearby at the same time.

According to an embodiment, the present invention provides a partial privacy module including a light control film, a first upper light guide plate, and a first light source. The first upper light guide plate, disposed on one side of the light control film, includes a first light incident surface, a first light emitting surface, a first bottom surface, and a plurality of first microstructures. The first bottom surface faces the light control film. The first light emitting surface is opposite to the first bottom surface. The first light incident surface is connected to the first light emitting surface and the first bottom surface. The first microstructures are disposed on at least one of the first light emitting surface and the first bottom surface. The first upper light guide plate includes at least one first block and at least one second block adjoined to the at least one first block. An average distribution density of a portion of the first microstructures on the at least one first block is greater than an average distribution density of another portion of the first microstructures on the at least one second block. The first light source is disposed on one side of the light incident surface.

In an embodiment, the partial privacy module further includes a second upper light guide plate and a second light source. The second upper light guide plate is disposed on one side of the light control film which is adjacent to the first upper light guide plate. The second upper light guide plate includes a second light incident surface, a second light emitting surface, a second bottom surface, and a plurality of second microstructures. The second bottom surface faces the light control film. The second light emitting surface is opposite to the second bottom surface. The second light incident surface is connected to the second light emitting surface and the second bottom surface. The second microstructures are disposed on at least one of the second light emitting surface and the second bottom surface. The second light source is disposed on one side of the second light incident surface. A spacing between the two adjacent second microstructures decreases as a distance from the second light source to the two adjacent second microstructures increases.

In an embodiment, when the first microstructures are not disposed on the first bottom surface corresponding to the at least one first block, the first microstructures are not disposed on the first bottom surface corresponding to the at least one second block; or when the first microstructures are not disposed on the first light emitting surface corresponding to the at least one first block, the first microstructures are not disposed on the first light emitting surface corresponding to the at least one second block.

In an embodiment, the average distribution density of the first microstructures on the at least one second block is zero.

In an embodiment, a quantity of the at least one first block is two, and a quantity of the at least one second block is one. The second block is located between the two first blocks.

In an embodiment, the first microstructures have a first height when the first microstructures are protrusions, the second microstructures have a second height when the second microstructures are protrusions, the first height is greater than 0 mm and less than or equal to 0.025 mm, and the second height is greater than 0 mm and less than or equal to 0.025 mm; or the first microstructures have a first depth when the first microstructures are recesses, the second microstructures have a second depth when the second microstructures are recesses, the first depth is greater than 0 mm and less than or equal to 0.025 mm, and the second depth is greater than 0 mm and less than or equal to 0.025 mm.

In an embodiment, a cross-sectional area of the first microstructures parallel to the first bottom surface or the first light emitting surface has a first length. A cross-sectional area of the second microstructures parallel to the second bottom surface or the second light emitting surface has a second length. The first length is greater than 0 mm and less than or equal to 0.05 mm, and the second length is greater than 0 mm and less than or equal to 0.05 mm.

In an embodiment, the partial privacy module further includes a third upper light guide plate and a third light source. The third upper light guide plate is disposed on one side of the first upper light guide plate which is away from the light control film. The third upper light guide plate includes a third light emitting surface, a third bottom surface, a third light incident surface, and a plurality of third microstructures. The third bottom surface faces the first light emitting surface. The third light incident surface is connected to the third light emitting surface and the third bottom surface. The third microstructures are disposed on at least one of the third light emitting surface and the third bottom surface. The third upper light guide plate includes at least one third block and at least one fourth block adjoined to the at least one third block. An average distribution density of a portion of the third microstructures on the at least one third block is greater than an average distribution density of another portion of the third microstructures on the at least one fourth block. The third light source is disposed on one side of the third light incident surface, and the third light source is disposed on one side of the third light incident surface. In an orthographic projection of the third upper light guide plate on the light control film, the at least one third block does not completely overlap with the at least one first block.

In an embodiment, when the third microstructures are not disposed on the third bottom surface corresponding to the at least one third block, the third microstructures are not disposed on the third bottom surface corresponding to the at least one fourth block; or when the third microstructures are not disposed on the third light emitting surface corresponding to the at least one third block, the third microstructures are not disposed on the third light emitting surface corresponding to the at least one fourth block.

In an embodiment, the average distribution density of the third microstructures on the at least one fourth block is zero.

In an embodiment, a quantity of the at least one fourth block is two, and a quantity of the at least one third block is one. The third block is located between the two fourth blocks.

In an embodiment, the third microstructures have a third height when the third microstructures are protrusions, and the third height is greater than 0 mm and less than or equal to 0.025 mm; or the third microstructures have a third depth when the third microstructures are recesses, and the third depth is greater than 0 mm and less than or equal to 0.025 mm.

In an embodiment, a cross-sectional area of the third microstructures parallel to the third bottom surface or the third light emitting surface has a third length, and the third length is greater than 0 mm and less than or equal to 0.05 mm.

According to an embodiment, the present invention provides a partial privacy display device including a backlight module, a partial privacy module, and a display panel. The backlight module includes a lower light guide plate and an optical film combination opposite to the lower light guide plate. The partial privacy module is disposed on one side of the optical film combination away from the lower light guide plate. The partial privacy module includes a light control film, a first upper light guide plate, and a first light source. The first upper light guide plate is disposed on one side of the light control film. The first upper light guide plate includes a first light incident surface, a first light emitting surface, a first bottom surface, and a plurality of first microstructures. The first bottom surface faces the light control film. The first light emitting surface is opposite to the first bottom surface. The first light incident surface is connected to the first light emitting surface and the first bottom surface. The first microstructures are disposed on at least one of the first light emitting surface and the first bottom surface. The first upper light guide plate includes at least one first block and at least one second block adjoined to the at least one first block. An average distribution density of a portion of the first microstructures on the at least one first block is greater than an average distribution density of another portion of the first microstructures on the at least one second block. The first light source is disposed on one side of the first light incident surface. The display panel is disposed on one side of the partial privacy module away from the backlight module.

In an embodiment, the partial privacy module further includes a second upper light guide plate and a second light source. The second upper light guide plate is disposed on one side of the light control film adjacent to the first upper light guide plate. The second upper light guide plate includes a second light incident surface, a second bottom surface, a second light emitting surface, and a plurality of second microstructures. The second light emitting surface is opposite to the second bottom surface. The second light incident surface is connected to the second light emitting surface and the second bottom surface. The second microstructures are disposed on at least one of the second light emitting surface and the second bottom surface. The second light source is disposed on one side of the second light incident surface. A spacing between the two adjacent second microstructures decreases as a distance from the second light source to the two adjacent second microstructures increases.

In an embodiment, the partial privacy module further includes a third upper light guide plate and a third light source. The third upper light guide plate is disposed on one side of the first upper light guide plate away from the light control film. The third upper light guide plate includes a third light emitting surface, a third bottom surface, a third light incident surface, and a plurality of third microstructures. The third light emitting surface is opposite to the third bottom surface. The third bottom surface faces the first light emitting surface. The third light incident surface is connected to the third light emitting surface and the third bottom surface. The third microstructures are disposed on at least one of the third light emitting surface and the third bottom surface. The third upper light guide plate includes at least one third block and at least one fourth block adjoined to the at least one third block. An average distribution density of a portion of the third microstructures on the at least one third block is greater than an average distribution density of another portion of the third microstructures on the at least one fourth block. The third light source is disposed on one side of the third light incident surface. In an orthographic projection of the third upper light guide plate on the light control film, the at least one third block does not completely overlap with the at least one first block.

In an embodiment, the partial privacy module further includes at least one switch button. The at least one switch button is electrically connected to at least one of the first light source and the third light source.

In an embodiment, the optical film combination includes at least one of at least one diffusion film, at least one light enhancing film, and at least one prism. The backlight module is a direct backlight module or an edge backlight module.

The present invention utilizes different distribution densities of the microstructures to make the light beams entering the light guide plate be refracted and reflected in different degrees, thereby achieving the result of partially displaying the screen contents and fully displaying the screen contents. By switching different light sources, the partial privacy display device could attain the results of privacy for the whole screen, privacy for the partial screen, and displaying the whole screen.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic cross-sectional view of a partial privacy module according to a first embodiment of the present invention.

FIG. 2 is a schematic cross-sectional view of a partial privacy module according to a second embodiment of the present invention.

FIG. 3 is a schematic cross-sectional view of a partial privacy module according to a third embodiment of the present invention.

FIG. 4 is a schematic cross-sectional view of a partial privacy module according to a fourth embodiment of the present invention.

FIG. 5 is a schematic cross-sectional view of a partial privacy module according to a fifth embodiment of the present invention.

FIG. 6 is a schematic cross-sectional view of a partial privacy module according to a sixth embodiment of the present invention.

FIG. 7 is a schematic cross-sectional view of a partial privacy module according to a seventh embodiment of the present invention.

FIG. 8 is a schematic cross-sectional view of a partial privacy module according to an eighth embodiment of the present invention.

FIG. 9 is a schematic cross-sectional view of a partial privacy module according to a ninth embodiment of the present invention.

FIG. 10A and FIG. 10B are schematic bottom views of a first upper light guide plate and a third upper light guide plate of a partial privacy module according to a tenth embodiment of the present invention.

FIG. 11A and FIG. 11B are schematic bottom views of a first upper light guide plate and a third upper light guide plate of a partial privacy module according to an eleventh embodiment of the present invention.

FIG. 12A and FIG. 12B are schematic bottom views of a first upper light guide plate and a third upper light guide plate of a partial privacy module according to a twelfth embodiment of the present invention.

FIG. 13 is a schematic cross-sectional view of a partial privacy display device according to the first embodiment of the present invention.

FIG. 14 is a schematic cross-sectional view of a partial privacy display device according to the second embodiment of the present invention.

FIG. 15 is a schematic cross-sectional view of a partial privacy display device according to the third embodiment of the present invention.

### DETAILED DESCRIPTION OF PREFERRED EMBODIMENTS

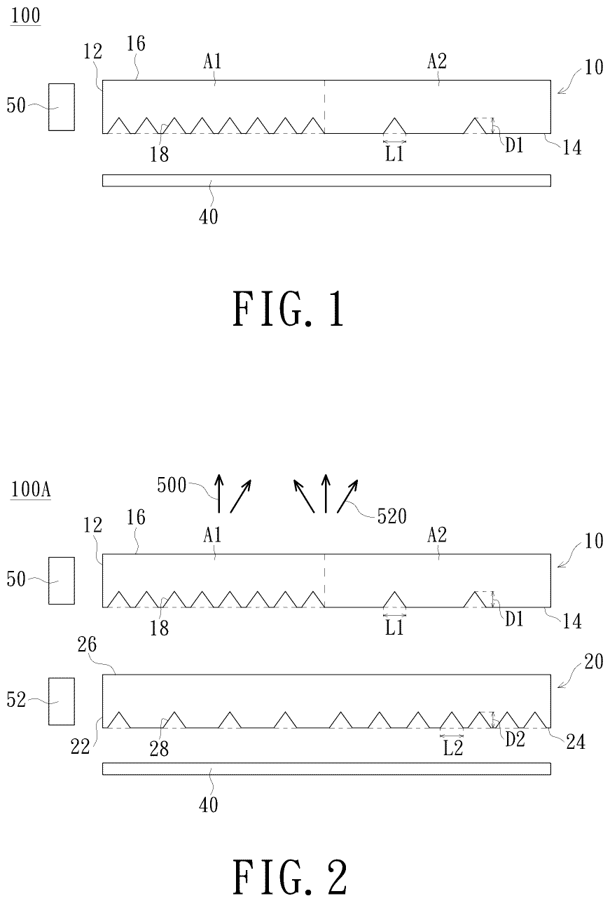

FIG. 1 is a schematic cross-sectional view of a partial privacy module according to a first embodiment of the present invention. As shown in FIG. 1, a partial privacy module 100 includes a light control film 40, a first upper light guide plate 10, and a first light source 50. The first upper light guide plate 10 is disposed on one side of the light control film 40. The first upper light guide plate 10 includes a first light incident surface 12, a first bottom surface 14, a first light emitting surface 16, and a plurality of first microstructures 18. The first bottom surface 14 faces the light control film 40. The first light emitting surface 16 is opposite to the first bottom surface 14. The first light incident surface 12 is connected to the first light emitting surface 16 and the first bottom surface 14. The first microstructures 18, such as recesses but not limited thereto, are disposed on the first bottom surface 14. The first upper light guide plate 10 includes a first block A1 and a second block A2 adjoined to each other. An average distribution density of a portion of the first microstructures 18 on the first block A1 is greater than an average distribution density of another portion of the first microstructures 18 on the second block A2. The first light source 50 is disposed on one side of the first light incident surface 12.

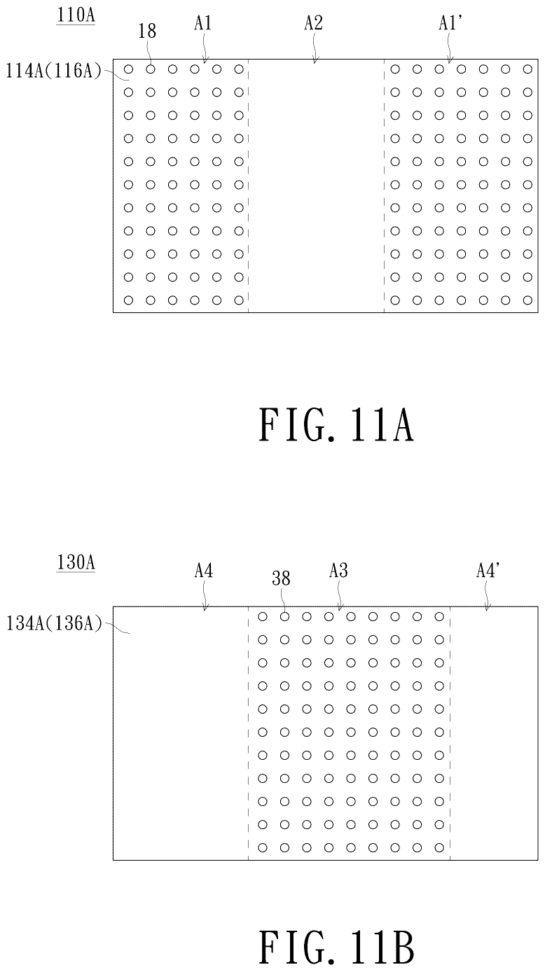

In an embodiment, it is understood that the average distribution density means a quantity of the microstructures in a unit area on a specific surface. For example, the quantity of the first microstructures 18 corresponding to the first block A1 on the first bottom surface 14 is the average distribution density of the first microstructures 18 on the first block A1 of the first bottom surface 14. As shown in FIG. 1, the average distribution density of a portion of the first microstructures 18 corresponding to the first block A1 of the first bottom surface 14 is greater than the average distribution density of another portion of the first microstructures 18 corresponding to the second block A2 of the first bottom surface 14. In an embodiment, the average distribution density of the first microstructures 18 on the first bottom surface 14 corresponding to the second block A2 is zero. In other words, there is no second microstructure 28 disposed on the first bottom surface 14 corresponding to the second block A2 (as shown in FIG. 11A). However, the present invention is not limited thereto.

FIG. 2 is a schematic cross-sectional view of a partial privacy module according to a second embodiment of the present invention. As shown in FIG. 2, a partial privacy module 100A further includes a second upper light guide plate 20 and a second light source 52 in comparison with the partial privacy module 100. The second upper light guide plate 20 is disposed on one side of the light control film 40 which is adjacent to the first upper light guide plate 10. For example, the second upper light guide plate 20 can be disposed between the light control film 40 and the first upper light guide plate 10; or the first upper light guide plate 10 can be disposed between the light control film 40 and the second upper light guide plate 20. As the partial privacy module 100A according to the second embodiment illustrated in FIG. 2, the second upper light guide plate 20 is disposed between the light control film 40 and the first upper light guide plate 10. The second upper light guide plate 20 includes a second light incident surface 22, a second bottom surface 24, a second light emitting surface 26, and a plurality of second microstructures 28. The second bottom surface 24 is opposite to the second light emitting surface 26. The second light emitting surface 26 faces the first bottom surface 14. The second light incident surface 22 is connected to the second bottom surface 24 and the second light emitting surface 26. The second microstructures 28, such as recesses but not limited thereto, are disposed on the second bottom surface 24. The second light source 52 is disposed on one side of the second light incident surface 22. In an embodiment, a spacing between the two adjacent second microstructures 28, located on the second bottom surface 24 of the second upper light guide plate 20, decreases as a distance from the second light source 52 to the two adjacent second microstructures 28 increases. In the same manner, in an embodiment, as a distance from the first light source 50 to the two adjacent first microstructures 18 increases, a spacing between the two adjacent first microstructures 18, located on the first bottom surface 14 corresponding to the first block A1, decreases, and the arrangement of the first microstructures 18 becomes denser.

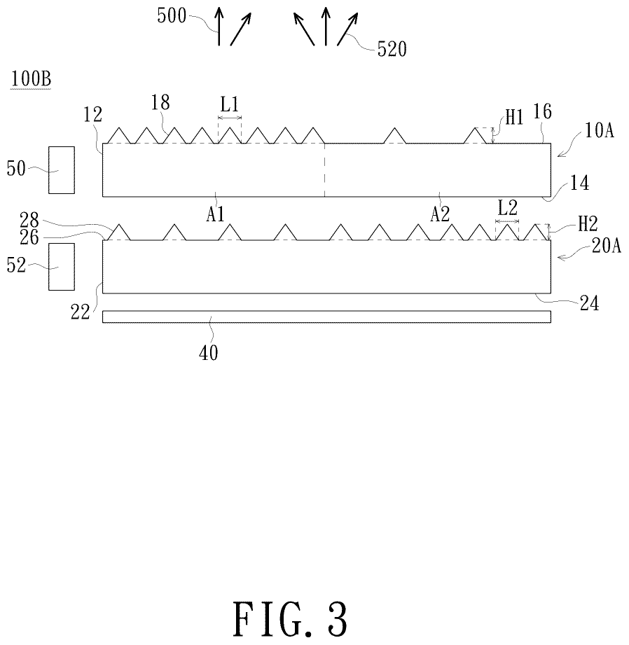

FIG. 3 is a schematic cross-sectional view of a partial privacy module according to a third embodiment of the present invention. As shown in FIG. 3, a partial privacy module 100B includes a light control film 40, a first upper light guide plate 10A, a second upper light guide plate 20A, a first light source 50, and a second light source 52. Here, the first upper light guide plate 10A has a different structure from the first upper light guide plate 10, and the second upper light guide plate 20A also has a different structure from the second upper light guide plate 20. In the first upper light guide plate 10A, the first microstructures 18, illustrated as protrusions here but not limited thereto, are disposed on the first light emitting surface 16. An average distribution density of a portion of the first microstructures 18 corresponding to the first block A1 on the first light emitting surface 16 is greater than an average distribution density of another portion of the first microstructures 18 corresponding to the second block A2 on the first light emitting surface 16. In the second upper light guide plate 20A, the second microstructures 28, such as protrusions but not limited thereto, are disposed on the second light emitting surface 26. A spacing between two adjacent second microstructures 28 on the second light emitting surface 28 decreases as a distance from the second light source 52 to the two adjacent second microstructures 28 increases. In an embodiment, as a distance from the first light source 50 to the two adjacent first microstructures 18 increases, a spacing between the two adjacent first microstructures 18, located on the first upper light guide plate 10 corresponding to the first block A1, decreases and the arrangement of the first microstructures 18 becomes denser.

As shown in FIG. 2 and FIG. 3, it is understood that whether the first microstructures 18 are disposed on the first bottom surface 14 or the first light emitting surface 16, the average distribution density of a portion of the first microstructures 18 on the first block A1 is greater than the average distribution density of another portion of the first microstructures 18 on the second block A2.

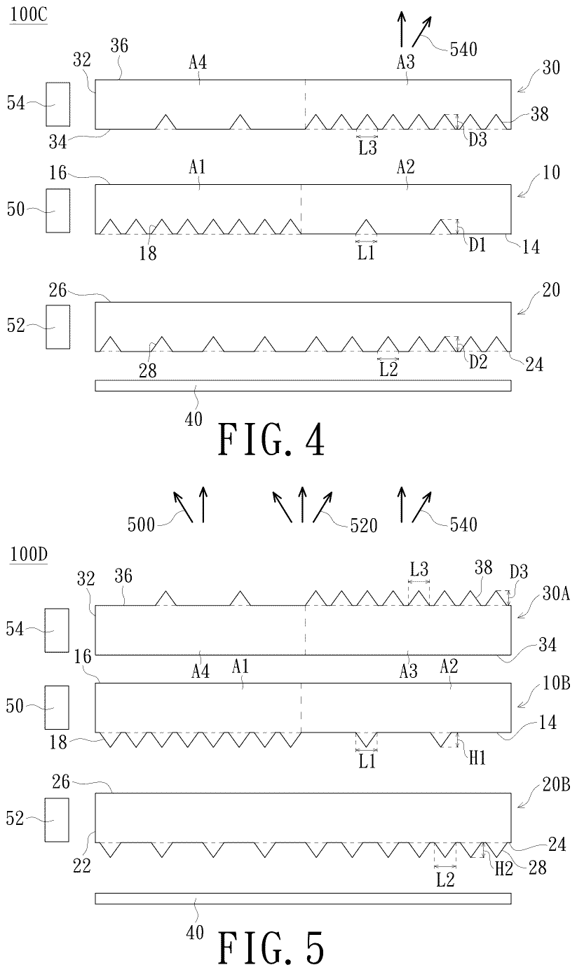

FIG. 4 is a schematic cross-sectional view of a partial privacy module according to a fourth embodiment of the present invention. As shown in FIG. 4, a partial privacy module 100C includes a light control film 40, a first upper light guide plate 10, a second upper light guide plate 20, a third upper light guide plate 30, a first light source 50, a second light source 52, and a third light source 54. In comparison with the partial privacy module 100A, the partial privacy module 100C further includes a third upper light guide plate 30 and a third light source 54. The third light guide plate 30 is disposed on one side of the first upper light guide plate 10 away from the light control film 40. As illustrated in FIG. 4, the partial privacy module 100C includes a first upper light guide plate 10 disposed between the second upper light guide plate 20 and the third upper light guide plate 30. The third upper light guide plate 30 includes a third light incident surface 32, a third bottom surface 34, a third light emitting surface 36, and a plurality of third microstructures 38. Here, the third bottom surface 34 is opposite to the third light emitting surface 36. The third bottom surface 34 faces the first light emitting surface 16. The third light incident surface 32 is connected to the third light emitting surface 36 and the third bottom surface 34. The third microstructures 38, illustrated as recesses here but not limited thereto, are disposed on the third bottom surface 34. The third upper light guide plate 30 includes a third block A3 and a fourth block A4 adjoined to each other. An average distribution density of a portion of the third microstructures 38 corresponding to the third block A3 on the third bottom surface 34 is greater than an average distribution density of another portion of the third microstructures 38 corresponding to the fourth block A4 on the third bottom surface 34. The third light source 54 is disposed on one side of the third light incident surface 32. In an orthographic projection of the third upper light guide plate 30 on the light control film 40, the third block A3 does not completely overlap with the first block A1. In an embodiment, as a distance from the third light source 54 to the two adjacent third microstructures 38 increases, a spacing between the two adjacent third microstructures 38 on the third bottom surface 34 corresponding to the third block A3, decreases and the arrangement of the third microstructures 38 becomes denser. Similar to the first upper light guide plate 10, in an embodiment, the average distribution density of the third microstructures 38 on the third bottom surface 34 corresponding to the fourth block A4 is zero. In other words, there is no third microstructure 38 disposed on the third bottom surface 34 corresponding to the fourth block A4 (as shown in FIG. 11B), but the invention is not limited thereto.

FIG. 5 is a schematic cross-sectional view of a partial privacy module according to a fifth embodiment of the present invention. As shown in FIG. 5, a partial privacy module 100D includes a light control film 40, a first upper light guide plate 10B, a second upper light guide plate 20B, a third upper light guide plate 30A, a first light source 50, a second light source 52, and a third light source 54. In comparison with the partial privacy module 100C, the first upper light guide plate 10B, the second upper light guide plate 20B, and the third upper light guide plate 30A in the partial privacy module 100D have different structures from the first upper light guide plate 10, the second upper light guide plate 20, and the third upper light guide plate 30 in the partial privacy module 100C. In the first upper light guide plate 10B, the first microstructures 18 are protrusions disposed on the first bottom surface 14. An average distribution density of a portion of the first microstructures 18 on the first bottom surface 14 corresponding to the first block A1 is greater than an average distribution density of another portion of the first microstructures 18 on the first bottom surface 14 corresponding to the second block A2. In the second upper light guide plate 20B, the second microstructures 28 are protrusions disposed on the second bottom surface 24 but not limited thereto. In the third upper light guide plate 30A, the third microstructures 38 are protrusions disposed on the third light emitting surface 36. An average distribution density of a portion of the third microstructures 38 on the third light emitting surface 36 corresponding to the third block A3 is greater than an average distribution density of another portion of the third microstructures 38 on the third light emitting surface 36 corresponding to the fourth block A4. In an embodiment, as a distance from the second light source 52 to the two adjacent second microstructures 28 increases, a spacing between the two adjacent second microstructures 28 on the second bottom surface 24 decreases, and the arrangement of the second microstructures 28 becomes denser.

As shown in FIG. 4 and FIG. 5, it is understood that whether the third microstructures 38 are disposed on the third bottom surface 34 or the third light emitting surface 36, the average distribution density of a portion of the third microstructures 38 on the third block A3 is greater than the average distribution density of another portion of the third microstructures 38 on the fourth block A4.

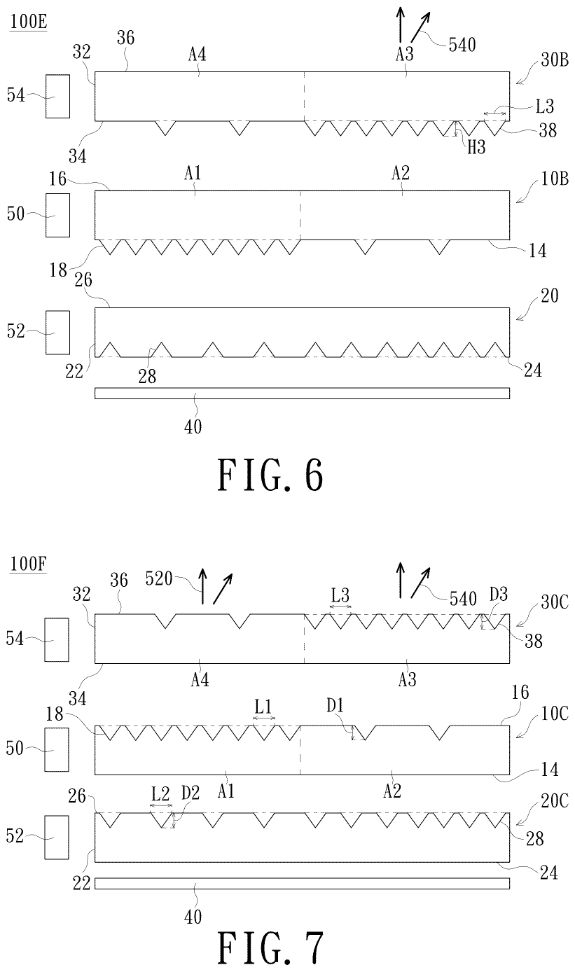

FIG. 6 is a schematic cross-sectional view of a partial privacy module according to a sixth embodiment of the present invention. As shown in FIG. 6, a partial privacy module 100E includes a light control film 40, a first upper light guide plate 10B, a second light guide plate 20, a third light guide plate 30B, a first light source 50, a second light source 52, and a third light source 54. In comparison with the partial privacy module 100C, in the partial privacy module 100E, the first microstructures 18 of the first upper light guide plate 10B are protrusions and the third microstructures 38 of the third upper light guide plate 30B are protrusions. The limitations related to the average distribution densities of the first microstructures 18, the second microstructures 28, and the third microstructures 38 are not reiterated here since they have been disclosed in the partial privacy module 100A in the second embodiment or the partial privacy module 100C in the fourth embodiment.

FIG. 7 is a schematic cross-sectional view of a partial privacy module according to a seventh embodiment of the present invention. As shown in FIG. 7, a partial privacy module 100F includes a light control film 40, a first upper light guide plate 10C, a second upper light guide plate 20C, a third upper light guide plate 30C, a first light source 50, a second light source 52, and a third light source 54. In comparison with the partial privacy module 100C, in the partial privacy module 100F, the first microstructures 18 of the first upper light guide plate 10C are recesses and are formed on a first light emitting surface 16, the second microstructures 28 of the second upper light guide plate 20C are recesses and are formed on a second light emitting surface 26, and the third microstructures 38 of the third upper light guide plate 30C are recesses and are formed on a third light emitting surface 36. The limitations related to the average distribution densities of the first microstructures 18, the second microstructures 28, and the third microstructures 38 are not reiterated here since they have been disclosed in the partial privacy module 100A in the second embodiment or the partial privacy module 100C in the fourth embodiment.

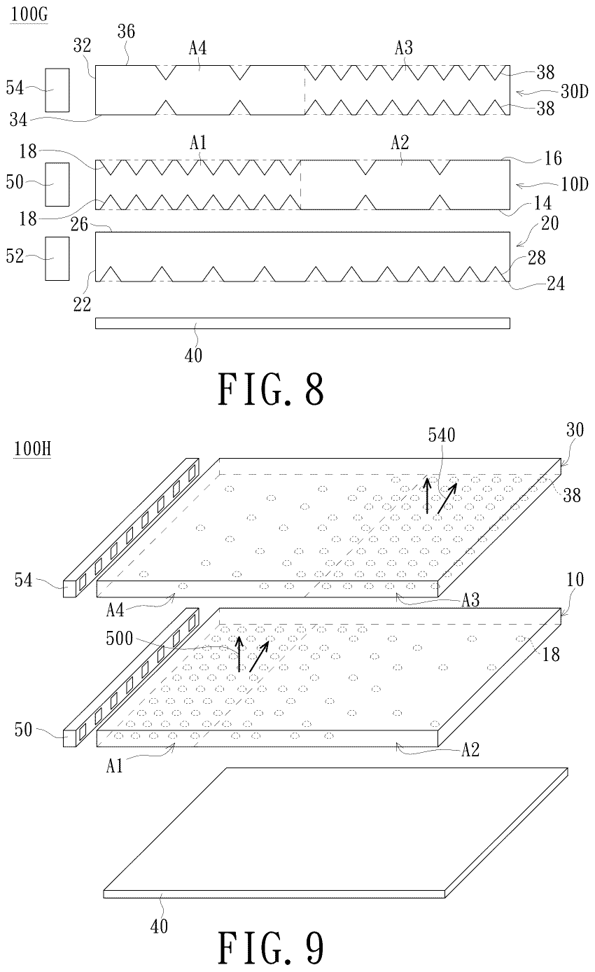

FIG. 8 is a schematic cross-sectional view of a partial privacy module according to an eighth embodiment of the present invention. As shown in FIG. 8, a partial privacy module 100G includes a light control film 40, a first upper light guide plate 10D, a second upper light guide plate 20, a third upper light guide plate 30D, a first light source 50, a second light source 52, and a third light source 54. In comparison with the partial privacy module 100C, in the partial privacy module 100G, the first microstructures 18 of the first upper light guide plate 10D are recesses formed on a first bottom surface 14 and a first light emitting surface 16, and the third microstructures 38 of the third upper light guide plate 30D are recesses formed on a third bottom surface 34 and a third light emitting surface 36. In one embodiment, the first microstructures 18, the second microstructures 28, and the third microstructures 38 of the partial privacy module 100G are protrusions.

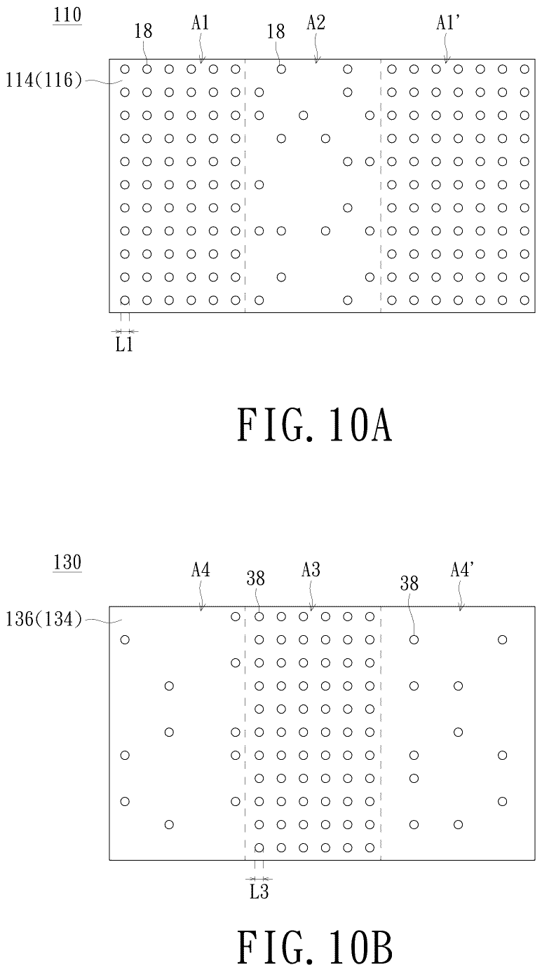

FIG. 9 is a schematic cross-sectional view of a partial privacy module according to a ninth embodiment of the present invention. As shown in FIG. 9, a partial privacy module 100H includes a light control film 40, a first upper light guide plate 10, a second upper light guide plate 20, a third upper light guide plate 30, a first light source 50, a second light source 52, and a third light source 54. In an orthographic projection of the third upper light guide plate 30 on the light control film 40, the first block A1 and the third block A3 do not adjoin or overlap each other.

In the embodiments mentioned above, the first microstructures 18, the second microstructures 28, or the third microstructures 38 may be cones, semi-spheres, or printing dots, but are not limited thereto. As shown in FIG. 9, the first microstructures 18 and the third microstructures 38 of the partial privacy module 100H are illustrated as semi-spheres but not limited thereto. Please refer to FIG. 5 to FIG. 9. In the orthographic projection of the third upper light guide plate 30 on the light control film 40, the third block A3 (a high distribution density area of the third microstructures 38 on the third bottom surface or the third light emitting surface 36) does not completely overlap with the first block A1 (a high distribution density area of the second microstructures 28 on the second bottom surface 24 or the second light emitting surface 26). In an embodiment, it is understood that the incomplete overlap means all situations except the complete overlap, and the complete overlap means that the orthographic projection areas are exactly the same. Therefore, the incomplete overlap includes the cases of partial overlap (such as the first block A1′ in FIG. 11A and the third block A3 in FIG. 11B), adjoined without overlap (such as FIG. 4 to FIG. 8), or neither overlapping nor adjoined (such as FIG. 9).

FIG. 10A and FIG. 10B are schematic bottom views of a first upper light guide plate and a third upper light guide plate of a partial privacy module respectively according to a tenth embodiment of the present invention. As shown in FIG. 10A, a first upper light guide plate 110 includes two first blocks A1 and A1′ and a second block A2 located between the two first blocks A1 and A1′. The first microstructures 18 may have the same or different average distribution densities on the first blocks A1 and A1′. The average distribution density of a portion of the first microstructures 18 on the first block A1 or A1′ is greater than the average distribution density of another portion of the first microstructures 18 on the second block A2. As shown in FIG. 10B, a third upper light guide plate 130 includes a third block A3 and two fourth blocks A4 and A4′. The third block A3 is located between the two fourth blocks A4 and A4′. The third microstructures 38 may have the same or different average distribution densities on the fourth blocks A4 and A4′. The average distribution density of the third microstructures 38 on the fourth block A4 or A4′ is less than the average distribution density of the third microstructures 38 on the third block A3. Please refer to FIG. 9 to FIG. 10B. In case that the first upper light guide plate 10 and the third upper light guide plate 30 in FIG. 9 are replaced by the first upper light guide plate 110 and the third upper light guide plate 130 in FIG. 10A and FIG. 10B, in an orthographic projection of the third upper light guide plate 130 on the light control film 40, the first blocks A1, A1′ and the second block A2 overlap with the fourth blocks A4, A4′ and the third block A3, respectively. In other words, the third block A3 does not completely overlap with the first block A1 or A1′, and more particularly, the third block A3 does not overlap with the first block A1 or A1′ but adjoins the first blocks A1 and A1′. However, the invention is not limited thereto.

FIG. 11A and FIG. 11B are schematic bottom views of a first upper light guide plate and a third upper light guide plate of a partial privacy module according to an eleventh embodiment of the present invention. As shown in FIG. 11A and FIG. 11B, a fist upper light guide plate 110A includes two first blocks A1 and A1′ and a second block A2 which is located between the two first blocks A1 and A1′. The first microstructures 18 may have the same or different average distribution densities on the first blocks A1 and A1′. There is no first microstructure 18 disposed on the second block A2. A third upper light guide plate 130A has a third block A3 and two fourth blocks A4 and A4′. The third block A3 is disposed between the two fourth blocks A4 and A4′. The third microstructures 38 are disposed on the third block A3 only, and none of the third microstructures 38 is disposed on the fourth block A4 or A4′. Please refer to FIG. 9, FIG. 11A, and FIG. 11B. In case that the first upper light guide plate 10 and the third upper light guide plate 30 are replaced by the first upper light guide plate 110A and the third upper light guide plate 130A respectively, in an orthographic projection of the third upper light guide plate 130A on the light control film 40, a portion of the third block A3 overlaps with the second block A2 while another portion of the third block A3 overlaps the first block A1′. In other words, the third block A3 does not completely overlap with the first block A1 or A1′, and more particularly, the third block A3 partially overlaps with the first block A1 or A1′. However, the invention is not limited thereto.

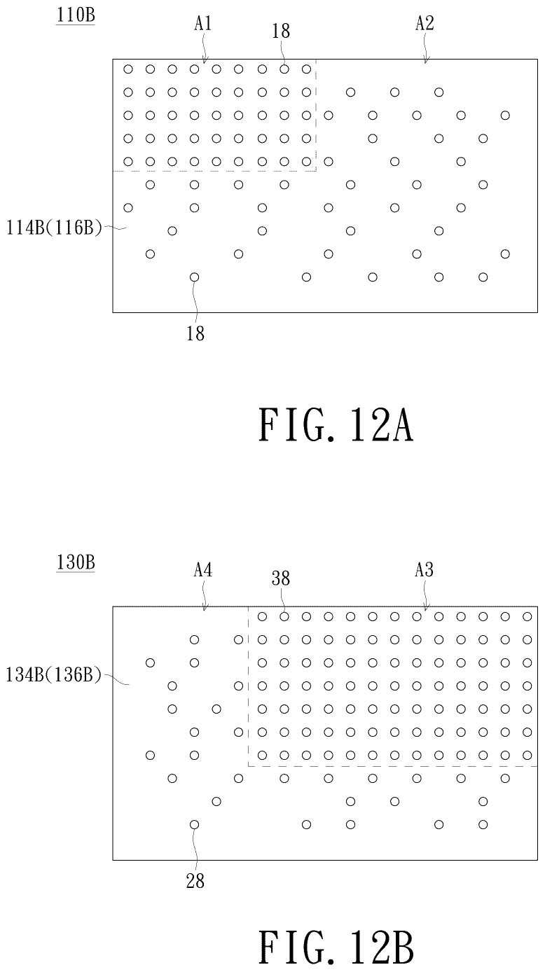

FIG. 12A and FIG. 12B are schematic bottom views of a first upper light guide plate and a third upper light guide plate of a partial privacy module according to a twelfth embodiment of the present invention. As shown in FIG. 12A and FIG. 12B, a first upper light guide plate 110B includes a first block A1 and a second block A2. The first block A1 is disposed on a corner of the first upper light guide plate 110B, but is not limited thereto. An average distribution density of a portion of the first microstructures 18 on the first block A1 is greater than an average distribution density of another portion of the first microstructures 18 on the second block A2. A third upper light guide plate 130B has a third block A3 and a fourth block A4. The third block A3 is disposed on a corner of the third upper light guide plate 130B, but is not limited thereto. An average distribution density of a portion of the third microstructures 38 on the third block A3 is greater than an average distribution density of another portion of the third microstructures 38 on the fourth block A4. Taking the first upper light guide plate 110B and the third upper light guide plate 130B as an example, the first block A1 is illustrated as rectangular and the first block A1 has at least two adjacent sides adjoined to the second block A2. The third block A3 is illustrated as rectangular and the third block A3 has at least two adjacent sides adjoined to the fourth block A4. The invention is not limited thereto. Please refer to FIG. 9, FIG. 12A, and FIG. 12B. In case of replacing the first upper light guide plate 10 and the third upper light guide plate 30 with the first upper light guide plate 110B and the third upper light guide plate 130B respectively, in an orthographic projection of the third upper light guide plate 130B on the light control film 40, the first block A1 partially overlaps the third block A3 and the fourth block A4.

According to FIG. 4 to FIG. 12B, it is understood that the first upper light guide plate 10/10A/10B/10C/10D/110/110A/110B and the third upper light guide plate 30/30A/30B/30C/30D/130/130A/130B can be used in any combination while the first block A1 does not completely overlap the third block A3 in the orthographic projection.

According to FIG. 1 to FIG. 8, it is understood that the first microstructures 18 can be disposed on at least one of the first bottom surface 14 and the first light emitting surface 16. The second microstructures 28 can be disposed on at least one of the second bottom surface 24 and the second light emitting surface 26. The third microstructures 38 can be disposed on at least one of the third bottom surface 34 and the third light emitting surface 36. When the first microstructures 18 are not disposed on the first bottom surface 14 corresponding to the first block A1, the first microstructures 18 are not disposed on the first bottom surface 14 corresponding to the second block A2; or when the first microstructures 18 are not disposed on the first light emitting surface 16 corresponding to the first block A1, the first microstructures 18 are not disposed on the first light emitting surface 16 corresponding to the second block A2. In the same manner, when the third microstructures 38 are not disposed on the third bottom surface 34 corresponding to the third block A3, the third microstructures 38 are not disposed on the third bottom surface 34 corresponding to the fourth block A4; or when the third microstructures 38 are not disposed on the third light emitting surface 36 corresponding to the third block A3, the third microstructures 38 are not disposed on the third light emitting surface 36 corresponding to the fourth block A4.

The aforementioned microstructures include recesses or protrusions. It is understood that a recess is a structure extending inward from the surface into an object. A depth of a recess is defined as the maximum distance from the surface to the recess along the normal direction of the surface. As shown in FIG. 1, FIG. 2, FIG. 4, and FIG. 7, the first microstructures 18, the second microstructures 28, and the third microstructures 38 are recesses. The first microstructures 18 have a first depth D1 corresponding to the first bottom surface 14 or the first light emitting surface 16. The first depth D1 is greater than 0 mm and less than or equal to 0.025 mm. The second microstructures 28 have a second depth D2 corresponding to the second bottom surface 24 or the second light emitting surface 26. The second depth D2 is greater than 0 mm and less than or equal to 0.025 mm. The third microstructures 38 have a third depth D3 corresponding to the third bottom surface 34 or the third light emitting surface 36. The third depth D3 is greater than 0 mm and less than or equal to 0.025 mm. The first depth D1, the second depth D2, and the third depth D3 can be the same or different.

On the contrary, a protrusion is a structure rising from the surface. A height of a protrusion is defined as the maximum distance from the surface to the protrusion along the normal direction of the surface. As shown in FIG. 3, FIG. 5, and FIG. 6, the first microstructures 18, the second microstructures 28, and the third microstructures 38 are protrusions. The first microstructures 18 have a first height H1 corresponding to the first bottom surface 14 or the first light emitting surface 16. The first height H1 is greater than 0 mm and less than or equal to 0.025 mm. The second microstructures 28 have a second height H2 corresponding to the second bottom surface 24 or the second light emitting surface 26. The second height H2 is greater than 0 mm and less than or equal to 0.025 mm. The third microstructures 38 have a third height H3 corresponding to the third bottom surface 34 or the third light emitting surface 36. The third height H3 is greater than 0 mm and less than or equal to 0.025 mm. The first height H1, the second height H2, and the third height H3 can be the same or different.

Please refer to FIG. 1 to FIG. 7 and FIG. 10A to FIG. 10B. A cross-sectional area of the first microstructures 18 parallel to the first bottom surface 14 or the first light emitting surface 16, such as a circle, has a first length L1, such as the diameter of the circle. The first length L1 is greater than 0 mm and less than or equal to 0.05 mm. A cross-sectional area of the second microstructures 28 parallel to the second bottom surface 24 or the second light emitting surface 26, such as a circle, has a second length L2, such as the diameter of the circle. The second length L2 is greater than 0 mm and less than or equal to 0.05 mm. A cross-sectional area of the third microstructures 38 parallel to the third bottom surface 34 or the third light emitting surface 36, such as a circle, has a third length L3, such as the diameter of the circle. The third length L3 is greater than 0 mm and less than or equal to 0.05 mm. In another embodiment which is not illustrated, a cross-sectional area of the first microstructures 18 parallel to the first bottom surface 14 or the first light emitting surface 16 is a polygon or a composite shape. A first length L1 is defined as the greatest distance within the polygon or the composite shape. A second length L2 and a third length L3 can be defined in the same manner.

The light beams for the partial privacy module 100/100A/100B/100C/100D/100E/100F/100G/100H come from the first light source 50, the second light source 52, and the third light source 54. Thus, the light transmission effect displayed on the partial privacy module 100/100A/100B/100C/100D/100E/100F/100G/100H is determined based on the turned-on light sources and the corresponding upper light guide plates. Please refer to FIG. 1 to FIG. 9. In the first upper light guide plate 10/10A/10B/10C/10D, the first microstructures 18 are disposed on at least one of the first bottom surface 14 and the first light emitting surface 16. When only the first light source 50 is turned on, the light beams 500 provided by the first light source 50 are reflected by a partial area on the first bottom surface 14 corresponding to the first microstructures 18 and then are emitted from the first light emitting surface 16; or the light beams 500 provided by the first light source 50 are refracted by a partial area on the first light emitting surface 16 corresponding to the first microstructures 18. Since the light beams 500 reflected or refracted from the first block A1 is much more than the light beams 500 reflected or refracted from the second block A2, the brightness of the light beams 500 emitted from the first light emitting surface 16 corresponding to the first block A1 is much greater than the brightness of the light beams 500 emitted from the first light emitting surface 16 corresponding to the second block A2. In addition, the light beams 500 provide a smaller viewing angle and are deflected. In an embodiment, when the average distribution density of the first microstructures 18 in the second block A2 is zero, there is no light beam emitted from the first light emitting surface 16 corresponding to the second block A2. In other words, the light beams 500 provided by the first light source 50 are only emitted from the first light emitting surface 16 corresponding to the first block A1. Thus, by preventing the light beams 500 from emitting from the first light emitting surface 16 of the first upper light guide plate 10/10A/10B/10C/10D corresponding to the second block A2, a partial transparency (or partial opaque) can be made and the light beams 500 from the partially transparent area are deflected.

Please refer to FIG. 2 to FIG. 8. In the second upper light guide plate 20/20A/20B/20C, the second microstructures 28 are disposed on either the second bottom surface 24 or the second light emitting surface 26. When only the second light source 52 is turned on, light beams 520 provided by the second light source 52 are reflected by the second bottom surface 24 and then are emitted outward from a whole plane of the second light emitting surface 26 so as to provide a whole-plane transparency with a maximum viewing angle. In an embodiment, in order to generate a uniform brightness of the light beams 520 emitted from the second light emitting surface 26, a spacing between the two adjacent second microstructures 28, disposed on the second bottom surface 24 or the second light emitting surface 26, decreases as a distance from the second light source 52 to the two adjacent second microstructures 28 increases and the arrangement of the second microstructures 28 becomes denser.

In summary, taking the partial privacy module 100A in FIG. 2 as an example, when only the first light source 50 and the second light source 52 are turned on, the light beams 520 are emitted from the whole plane of the second light emitting surface 26 and pass through the first light emitting surface 16 of the first upper light guide plate 10 so as to provide a whole-plane transparency with a maximum viewing angle. Since the light beams 500 are emitted from the first light emitting surface 16 corresponding to the first block A1, the light beams 500 and the light beams 520 are cumulated. Therefore, the brightness of the first light emitting surface 16 corresponding to the first block A1 is greater than the brightness of the first light emitting surface 16 corresponding to the second block A2. In the same manner, the partial privacy modules 100B, 100C, 100D, 100E, 100F, and 100G have the same effect.

Please refer to FIG. 4 to FIG. 9. The third upper light guide plate 30/30A/30B/30C/30D has the same optical effect as the first upper light guide plate 10/10A/10B/10C/10D because of the same optical principle. The third microstructures 38 are disposed on at least one of the third bottom surface 34 and the third light emitting surface 36. When only the third light source 54 is turned on, light beams 540 are reflected by a partial area on the third bottom surface 34 with the third microstructures 38, and are emitted from the third light emitting surface 36; or light beams 540 are refracted by a partial area on the third light emitting surface 36 with the third microstructures 38. Since the light beams 540 reflected or refracted through the third block A3 are much more than the light beams 540 reflected or refracted through the fourth block A4, the brightness of the light beams 540 emitted from the third light emitting surface 36 corresponding to the third block A3 is much greater than the brightness of the light beams 540 emitted from the third light emitting surface 36 corresponding to the fourth block A4. The light beams 540 have a smaller viewing angle and are deflected. In an embodiment, when the average distribution density of the third microstructures 38 on the fourth block is zero, none of the light beams 540 is emitted from the third light emitting surface 36 corresponding to the fourth block A4. In other words, the light beams 540 are only emitted from the third light emitting surface 36 corresponding to the third block A3. Thus, by preventing the light beams from being emitted from a portion of the third bottom surface 34, an effect of partial transparency (partial opaque) can be made.

In summary, taking the partial privacy module 100D in FIG. 5 as an example, when only the second light source 52 and the third light source 54 are turned on, the optical principles and the transparency effect are similar to the case of turning on the first light source 50 and the second light source 52 only. The light beams 520 are emitted from the whole plane of the second light emitting surface 26 and pass through the third light emitting surface 36 of the third upper light guide plate 30A so as to provide a whole-plane transparency with a maximum viewing angle. Since the light beams 540 are emitted from the third light emitting surface 36 corresponding to the third block A3, the brightness of the third light emitting surface 36 corresponding to the third block A3 is greater than the brightness of the third light emitting surface 36 corresponding to the fourth block A4 because of the cumulation of the light beams 540 and the light beams 520. In the same manner, the partial privacy modules 100C, 100E, 100F, and 100G have the same effect.

In the same manner, taking the partial privacy module 100D as an example, when the first light source 50 and the third light source 54 are turned on at the same time and the second light source 52 is turned off, the light beams 500 are mainly emitted from the first light emitting surface 16 corresponding to the first block A1 and pass through the third upper light guide plate 30A, and the light beams 540 are emitted from the third light emitting surface 36 corresponding to the third block A3. Since the first block A1 and the third block A3 do not completely overlap in an orthographic projection of the third upper light guide plate 30A on the light control film 40, when the light beams 500 and the light beams 540 are emitted from the third light emitting surface 36, the transparent area is determined based on the coverage of the first block A1 and the third block A3 in the orthographic projection. Accordingly, an effect of the whole-plane transparency or partial transparency may be made. However, the light beams 500, emitted from the first light emitting surface 16 and the third light emitting surface 36, and the light beams 540, emitted from the third light emitting surface 36, are deflected. Though the effect of the whole-plane transparency can be made, the effect is different from the case of turning on the second light source 52 only. In the same manner, the partial privacy modules 100C, 100E, 100F, 100G, and 100H have the same effect.

In summary, taking the partial privacy module 100D as an example, when the first light source 50, the second light source 52, and the third light source 54 are turned on at the same time, all the light beams 500, 520, and 540 are emitted from the third light emitting surface 36. The whole plane is transparent, the whole light beams are not deflected, and the overall brightness increases. The third light emitting surface 36 has the greatest brightness at the positions corresponding to the first block A1 and the third block A3 in the orthographic projection or at the positions where the first block A1 and the third block A3 overlap in the orthographic projection.

As shown in FIG. 8, since the partial privacy module 100G includes the features of the partial privacy module 100C according to the fourth embodiment and the partial privacy module 100F according to the seventh embodiment, the optical principles and the transparency effect of the partial privacy module 100G are as described above and are not reiterated here.

It is understood that in the partial privacy module 100/100A/100B/100C/100D/100E/100F/100G/100H, the light control film 40 and the first upper light guide plate 10/10A/10B/10C/10D may be arbitrarily combined with at least one of the second upper light guide plate 20/20A/20B/20C and the third upper light guide plate 30/30A/30B/30C/30D, or may not be combined with any of them. When the first upper light guide plate 10/10A/10B/10C/10D is combined with the second upper light guide plate 20/20A/20B/20C and/or the third upper light guide plate 30/30A/30B/30C/30D, the relative positions are interchangeable.

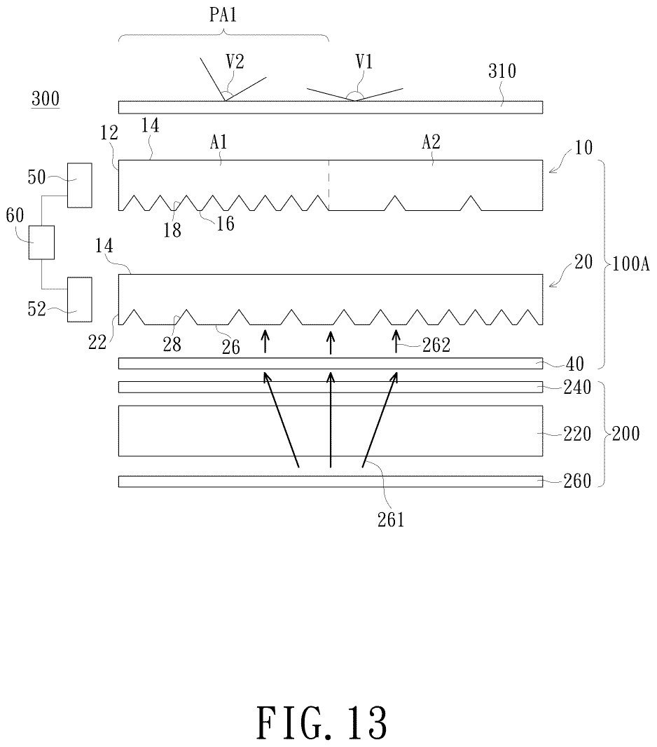

FIG. 13 is a schematic cross-sectional view of a partial privacy display device according to the first embodiment of the present invention. As shown in FIG. 13, a partial privacy display device 300 includes a backlight module 200, a partial privacy module 100A, and a display panel 310. The invention is not limited thereto. The partial privacy module 100A has been described above and is not reiterated here. In an embodiment, the backlight module 200 is a direct backlight module and includes a lower light guide plate 220, an optical film combination 240, and a backlight source 260. The lower light guide plate 220, opposite to the optical film combination 240, is disposed between the backlight source 260 and the optical film combination 240. In an orthographic projection of the display panel 310 on the backlight module 200, the first block A1 of the first upper light guide plate 10 overlaps with a first displaying area PA1 of the display panel 310. After light beams 261 provided by the backlight source 260 pass through the lower light guide plate 220 and the optical film combination 240, they are transmitted to a light control film 40 in the partial privacy module 100A to form collimated light beams 262 and finally are provided to the display panel 310.

When the light beams are only provided by the backlight source 260, the partial privacy display device 300 provides a small viewing angle and thereby achieves an effect of full-screen privacy. When the backlight source 260 is turned on together with the first light source 50, the second light source 52, or the third light source 54, an effect of full-screen sharing or partial sharing (partial privacy) is provided. As shown in FIG. 13, when only the backlight source 260 and the first light source 50 are turned on, the backlight source generates the collimated light beams 262 through the light control film 40 to the display panel 31, thereby providing users a front view with a small viewing angle. In addition, by using the reflection from the first block A1, the first light source 50 can provide the first displaying area PA1 a deflected side view with a small viewing angle, thereby forming a view V2 which is deflected away from the second light source 52. In other words, when the backlight source 260 and the first light source 50 are turned on at the same time, the user in the frontal view can share the screen contents in the first displaying area PA1 with a bystander located on one side of the user and prevent another bystander located on another side from viewing them, leading to the effect of partial sharing and partial privacy. When only the backlight source 260 and the second light source 52 are turned on, since the partial privacy module 100A is fully transparent, the display panel 310 can provide a view V1 of full-screen sharing.

In an embodiment which is not illustrated, the partial privacy module 100A in the privacy display device 300 is replaced by the privacy module 100. When the first light source 50 is turned off and only the backlight source 260 is turned on, the partial privacy display device 300 can provide a user a front view with a small view angle, leading to the effect of full-screen privacy. On the contrary, when the first light source 50 and the backlight source 260 are both turned on, a user in the frontal view of the partial privacy display device 300 can share the screen contents in the first displaying area PA1 with a bystander located on one side and prevent another bystander on another side from viewing the screen contents, leading to the effect of partial sharing and partial privacy.

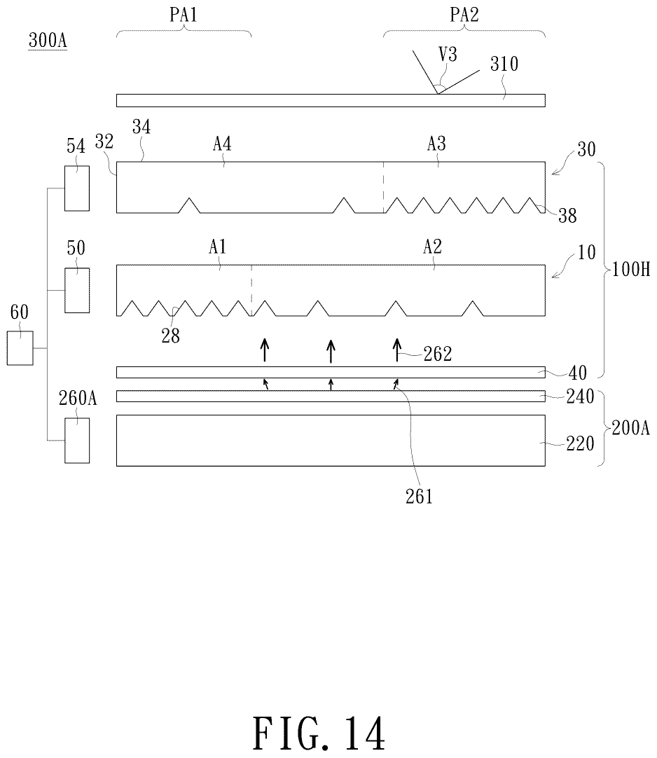

FIG. 14 is a schematic cross-sectional view of a partial privacy display device according to the second embodiment of the present invention. As shown in FIG. 14, the partial privacy display device 300A includes a backlight module 200A, a partial privacy module 100H, and a display panel 310. The partial privacy module 100H has been described above and is not reiterated here. In an embodiment, the backlight module 200A is an edge backlight module including a lower light guide plate 220, an optical film combination 240, and a backlight source 260A. The lower light guide plate 220 is disposed opposite to the optical film combination 240, and the backlight source 260A is disposed on one side of the lower light guide plate 220. In an orthographic projection of the display panel 310 on the backlight module 200, the first block A1 of the first upper light guide plate 10 neither overlaps nor adjoins the third block A3 of the third upper light guide plate 30. The first block A1 overlaps with a first displaying area PA1, and the third block A3 overlaps with a second displaying area PA2. However, the invention is not limited thereto.

When only the backlight source 260A is turned on, light beams 261 from the backlight source 260 are transformed to collimated light beams 262 through the light control film 40 and then are transmitted to the display panel 310. Thus, the partial privacy display device 300A can provide a user a front view with a small viewing angle, leading to an effect of full-screen privacy. When only the first light source 50 and the backlight source 260A are turned on, the user in the frontal view can share the screen contents in the first displaying area PA1 to a bystander on one side and prevent another bystander on another side from viewing the content, leading to an effect of partial sharing and partial privacy (as shown in FIG. 13). Similar to the first display area PA1, the contents in the second display area PA2 can be shared by utilizing different light sources and corresponding upper light guide plates. When only the backlight source 260 and the third light source 54 are turned on, in addition to the front view with a small viewing angle provided by the collimated light beams 262 to the user, a side view with a deflected viewing angle corresponding to the second displaying area PA2 is also provided by the third light source 54 through reflection or refraction from the third block A3, thereby forming a view V3 which is deflected to a direction away from the third light source 54. In other words, when the backlight source 260 and the third light source 54 are turned on at the same time, the user in the frontal view can share the contents in the second displaying area PA2 to a bystander on one side and prevent another bystander on another side from viewing them, leading to the effect of partial sharing and partial privacy.

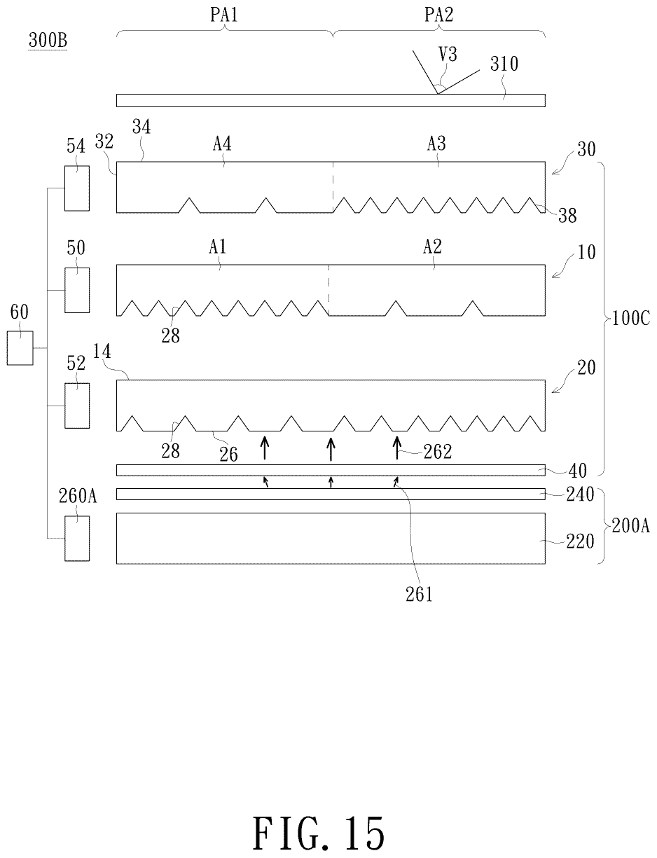

FIG. 15 is a schematic cross-sectional view of a partial privacy display device according to the third embodiment of the present invention. As shown in FIG. 15, a partial privacy display device 300B includes a backlight module 200A, a partial privacy module 100C, and a display panel 310, but the invention is not limited thereto. The backlight module 200A and the partial privacy module 100C are the same as mentioned above and are not reiterated here. In addition, various effects of turning on the backlight source 260A only, the backlight source 260A and the first light source 50 only, the backlight source 260A and the second light source 52 only, or the backlight source 260A and the third light source 54 only, have been described above and are not reiterated here.

It is understood that when the backlight source 260, the first light source 50, and the third light source 54 are turned on, and the second light source 52 is turned off, the user in the frontal view can share the contents in the first displaying area PA1 and the second displaying area PA2 with a bystander on one side and prevent another bystander on another side from viewing them, leading to the effect of partial sharing and partial privacy.

In summary, it is understood that when the second light source 52 is turned on, the partial privacy display devices 300/300A/300B function in the mode of full-screen sharing. When the first light source 50 and/or the third light source 54 are turned on, the contents in the first displaying area PA1 and/or the second displaying area PA2 can be partially shared and partially anti-peeped. Turning off the backlight source 260 does not affect the views V1/V2/V3 but reduces the overall brightness, especially for the user in the frontal view.

As shown in FIG. 13 to FIG. 15, the partial privacy display device 300/300A further includes a switch button 60, which is electrically connected to at least one of the backlight source 260/260A, the first light source 50, the second light source 52, and the third light source 54. The switch button 60 is used for the on-off control of different light sources. In an embodiment, the switch button 60 is a multistage switch button which is electrically connected to the first light source 50 and the second light source 52, or the first light source 50, the second light source 52, and the third light source 54, so as to control the partial privacy display device 300/300A to operate in the modes of full-screen privacy, full-screen sharing, or partial sharing (partial privacy).

In the partial privacy display device 300/300A/300B, the optical film combination 240 includes at least one diffusion film, at least one light enhancing film, and at least one prism. The diffusion film can make the light beams 261 transmitted from the backlight source 260/260A to the partial privacy module 100A/100C/100H more uniform. The light enhancing film can enhance the intensity of the light beams 261 transmitted from the backlight source 260/260A to the partial privacy module 100A/100C/100H. The prism can adjust the angles of the light beams 261 transmitted to the partial privacy module 100A/100C/100H, and more particularly, a reverse prism can provide a better collimating effect to the light beams 261 transmitted from the backlight source 260/260A to the partial privacy module 10A/100C/100H after the light beams 261 pass through the light control film 40.

It is understood that the backlight module 200/200A and the display panel 310 can be combined with any of the aforementioned partial privacy modules 100/100A/100B/100C/100D/100E/100F/100G/100H or modifications thereof to form a partial privacy display device.

The present invention utilizes different distribution densities of the microstructures to make the light beams entering the light guide plate be reflected or refracted in varying degrees. The partial privacy module is formed by using different arrangement of microstructures and a corresponding light source combination. As a result, the light emission brightness varies in different areas and the light emitting angle is deflected. When the partial privacy module is combined with the backlight module and the display panel to form the partial privacy display device, by switching different light sources, the partial privacy display device is enabled to achieve full-screen privacy, full-screen sharing, or partial sharing (partial privacy). Additionally, the partial sharing allows the user in the frontal view to share with a single side.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A partial privacy module, comprising:
a light control film;
a first upper light guide plate, disposed on one side of the light control film, wherein the first upper light guide plate comprises a first light incident surface, a first light emitting surface, a first bottom surface, and a plurality of first microstructures, the first bottom surface faces the light control film, the first light emitting surface is opposite to the first bottom surface, the first light incident surface is connected to the first light emitting surface and the first bottom surface, the first microstructures are disposed on at least one of the first light emitting surface and the first bottom surface, the first upper light guide plate comprises at least one first block and at least one second block adjoined to the at least one first block, and an average distribution density of a portion of the first microstructures on the at least one first block is greater than an average distribution density of another portion of the first microstructures on the at least one second block; and
a first light source, disposed on one side of the first light incident surface.

2. The partial privacy module according to claim 1, further comprising a second upper light guide plate and a second light source, wherein the second upper light guide plate is disposed on one side of the light control film which is adjacent to the first upper light guide plate, the second upper light guide plate comprises a second light incident surface, a second light emitting surface, a second bottom surface, and a plurality of second microstructures, the second bottom surface faces the light control film, the second light emitting surface is opposite to the second bottom surface, the second light incident surface is connected to the second light emitting surface and the second bottom surface, the second microstructures are disposed on at least one of the second light emitting surface and the second bottom surface, the second light source is disposed on one side of the second light incident surface, and a spacing between the two adjacent second microstructures decreases as a distance from the second light source to the two adjacent second microstructures increases.

3. The partial privacy module according to claim 2, wherein:
when the first microstructures are not disposed on the first bottom surface corresponding to the at least one first block, the first microstructures are not disposed on the first bottom surface corresponding to the at least one second block; or
when the first microstructures are not disposed on the first light emitting surface corresponding to the at least one first block, the first microstructures are not disposed on the first light emitting surface corresponding to the at least one second block.

4. The partial privacy module according to claim 3, wherein the average distribution density of the first microstructures on the at least one second block is zero.

5. The partial privacy module according to claim 1, wherein a quantity of the at least one first block is two, a quantity of the at least one second block is one, and the second block is located between the two first blocks.

6. The partial privacy module according to claim 2, wherein:
the first microstructures have a first height when the first microstructures are protrusions, the second microstructures have a second height when the second microstructures are protrusions, the first height is greater than 0 mm and less than or equal to 0.025 mm, and the second height is greater than 0 mm and less than or equal to 0.025 mm; or the first microstructures have a first depth when the first microstructures are recesses, the second microstructures have a second depth when the second microstructures are recesses, the first depth is greater than 0 mm and less than or equal to 0.025 mm, and the second depth is greater than 0 mm and less than or equal to 0.025 mm.

7. The partial privacy module according to claim 2, wherein a cross-sectional area of the first microstructures parallel to the first bottom surface or the first light emitting surface has a first length, a cross-sectional area of the second microstructures parallel to the second bottom surface or the second light emitting surface has a second length, the first length is greater than 0 mm and less than or equal to 0.05 mm, and the second length is greater than 0 mm and less than or equal to 0.05 mm.

8. The partial privacy module according to claim 2, further comprising a third upper light guide plate and a third light source, wherein:
the third upper light guide plate is disposed on one side of the first upper light guide plate which is away from the light control film, the third upper light guide plate comprises a third light emitting surface, a third bottom surface, a third light incident surface, and a plurality of third microstructures, the third bottom surface faces the first light emitting surface, the third light incident surface is connected to the third light emitting surface and the third bottom surface, the third microstructures are disposed on at least one of the third light emitting surface and the third bottom surface, the third upper light guide plate comprises at least one third block and at least one fourth block adjoined to the at least one third block, an average distribution density of a portion of the third microstructures on the at least one third block is greater than an average distribution density of another portion of the third microstructures on the at least one fourth block, and the third light source is disposed on one side of the third light incident surface; and
in an orthographic projection of the third upper light guide plate on the light control film, the at least one third block does not completely overlap with the at least one first block.

9. The partial privacy module according to claim 8, wherein:
when the third microstructures are not disposed on the third bottom surface corresponding to the at least one third block, the third microstructures are not disposed on the third bottom surface corresponding to the at least one fourth block; or
when the third microstructures are not disposed on the third light emitting surface corresponding to the at least one third block, the third microstructures are not disposed on the third light emitting surface corresponding to the at least one fourth block.

10. The partial privacy module according to claim 9, wherein the average distribution density of the third microstructures on the at least one fourth block is zero.

11. The partial privacy module according to claim 9, wherein a quantity of the at least one fourth block is two, a quantity of the at least one third block is one, and the third block is located between the two fourth blocks.

12. The partial privacy module according to claim 8, wherein:
the third microstructures have a third height when the third microstructures are protrusions, and the third height is greater than 0 mm and less than or equal to 0.025 mm; or
the third microstructures have a third depth when the third microstructures are recesses, and the third depth is greater than 0 mm and less than or equal to 0.025 mm.

13. The partial privacy module according to claim 8, wherein a cross-sectional area of the third microstructures parallel to the third bottom surface or the third light emitting surface has a third length, and the third length is greater than 0 mm and less than or equal to 0.05 mm.

14. A partial privacy display device, comprising:
a backlight module, comprising a lower light guide plate and an optical film combination opposite to the lower light guide plate;
a partial privacy module, disposed on one side of the optical film combination away from the lower light guide plate, and the partial privacy module comprising:
a light control film;
a first upper light guide plate, disposed on one side of the light control film, wherein the first upper light guide plate comprises a first light incident surface, a first light emitting surface, a first bottom surface, and a plurality of first microstructures, the first bottom surface faces the light control film, the first light emitting surface is opposite to the first bottom surface, the first light incident surface is connected to the first light emitting surface and the first bottom surface, the first microstructures are disposed on at least one of the first light emitting surface and the first bottom surface, the first upper light guide plate comprises at least one first block and at least one second block adjoined to the at least one first block, and an average distribution density of a portion of the first microstructures on the at least one first block is greater than an average distribution density of another portion of the first microstructures on the at least one second block; and
a first light source, disposed on one side of the first light incident surface; and
a display panel, disposed on one side of the partial privacy module away from the backlight module.

15. The partial privacy display device according to claim 14, wherein the partial privacy module further comprises a second upper light guide plate and a second light source, the second upper light guide plate is disposed on one side of the light control film adjacent to the first upper light guide plate, the second upper light guide plate comprises a second light incident surface, a second bottom surface, a second light emitting surface, and a plurality of second microstructures, the second light emitting surface is opposite to the second bottom surface, the second light incident surface is connected to the second light emitting surface and the second bottom surface, the second microstructures are disposed on at least one of the second light emitting surface and the second bottom surface, the second light source is disposed on one side of the second light incident surface, and a spacing between the two adjacent second microstructures decreases as a distance from the second light source to the two adjacent second microstructures increases.

16. The partial privacy display device according to claim 15, wherein the partial privacy module further comprises a third upper light guide plate and a third light source, the third upper light guide plate is disposed on one side of the first upper light guide plate away from the light control film, the third upper light guide plate comprises a third light emitting surface, a third bottom surface, a third light incident surface, and a plurality of third microstructures, the third light emitting surface is opposite to the third bottom surface, the third bottom surface faces the first light emitting surface, the third light incident surface is connected to the third light emitting surface and the third bottom surface, the third microstructures are disposed on at least one of the third light emitting surface and the third bottom surface, the third upper light guide plate comprises at least one third block and at least one fourth block adjoined to the at least one third block, an average distribution density of a portion of the third microstructures on the at least one third block is greater than that on the at least one fourth block, the third light source is disposed on one side of the third light incident surface, and in an orthographic projection of the third upper light guide plate on the light control film, the at least one third block does not completely overlap with the at least one first block.

17. The partial privacy display device according to claim 16, further comprising at least one switch button, wherein the at least one switch button is electrically connected to at least one of the first light source and the third light source.

18. The partial privacy display device according to claim 16, wherein the optical film combination comprises at least one of at least one diffusion film, at least one light enhancing film, and at least one prism, and the backlight module is a direct backlight module or an edge backlight module.
